(19) United States
(12) Patent Application Publication
(10) Pub. No.: US 2016/0143444 A1
(43) Pub. Date: May 26, 2016

(54) YOGA STOOL

(71) Applicant: Lou LAN, Paia, HI (US)

(72) Inventor: Lou LAN, Paia, HI (US)

(21) Appl. No.: 14/950,536

(22) Filed: Nov. 24, 2015

Related U.S. Application Data
(60) Provisional application No. 62/084,121, filed on Nov. 25, 2014.

(51) Int. Cl. A47C 9/00; A61H 15/00; A47C 31/00

(52) U.S. Cl. CPC A47C 9/002; A47C 31/00; A61H 15/00; A61H 2015/0014

(57) ABSTRACT

A yoga stool may have a seat portion and a base portion; the base portion having window slot(s) formed in a front side, a rear side, or both; a handle slot formed at least in one side, such as the front side, at or near the top; horizontal gripping slot(s) formed in the left side, the right side, or both, at or near the top; and vertical gripping slot(s) formed in the left side, the right side, or both, at or near the bottom; advantageously four such slots being formed near the bottom corners of the left and right sides. A yoga stool also may have a base portion, and a seat portion on top of the base portion, wherein the seat portion has an internal firm support member such as a solid slat, and preferably softer material such as foam rubber surrounding the support member, at least on the left and right sides.

### CROSS-REFERENCE TO RELATED APPLICATION

This application is based on and claims priority to Provisional Application No. 62/084,121, filed Nov. 25, 2014, herein incorporated by reference.

### FIELD OF THE INVENTION

The invention relates to a stool, particularly for use in practicing yoga, having a combination of features adapted for facilitating a wide variety of yoga postures.

### BACKGROUND OF THE INVENTION

It is known to practice yoga while seated in a chair, or to incorporate a chair or another structure such as a wall into the yoga practice. However, chairs are not standardized and walls are not always accessible in a given space.

It would be desirable to provide a portable, compact, multi-function support unit to perform the functions of both chairs and walls in order to make the practice of yoga more comfortable and convenient.

It would further be desirable for the support unit to provide specific handholds and footholds to guide and facilitate the yoga practice.

### SUMMARY

Accordingly, according to one aspect of the invention, a yoga stool may comprise a seat portion and a base portion; the base portion having opposed top and bottom sides, opposed left and right sides, and opposed front and rear sides; a window slot formed in at least one of the front side and the rear side; a horizontal gripping slot formed in an upper portion of at least one of the left side and the right side; a vertical gripping slot formed in a lower portion of at least one of the left side and the right side. The yoga stool preferably may have at least two vertical gripping slots formed respectively in the lower portions of the left side and the right side, and even more preferably four vertical gripping slots formed in the lower portions of the left side and the right side, two of said slots being near or at the front side and two of the slots being near or at the back side, and/or two horizontal gripping slots formed respectively in the left side and the right side.

According to another aspect, a yoga stool may comprise a base portion, and a seat portion on top of the base portion; the base portion having opposed top and bottom sides, opposed left and right sides, and opposed front and rear sides; wherein the seat portion has an internal horizontal firm support member such as a solid slat, and soft material such as foam rubber surrounding the support member adjacent the left, right, front and rear sides.

Other features and advantages of the invention will be appreciated from the following description of embodiments thereof, with reference to the drawings.

### BRIEF DESCRIPTION OF THE DRAWINGS

FIG. 1 is a front right perspective view of a yoga stool according to an embodiment of the invention;

FIG. 2 is a rear right perspective view thereof;

FIG. 3 is a front elevation view thereof;

FIG. 4 is a rear elevation view thereof;

FIG. 5 is a left side elevation view thereof;

FIG. 6 is a right side elevation view thereof;

FIG. 7 is a top plan view thereof;

FIG. 8 is a bottom plan view thereof;

FIG. 9-12 show a user seated on the stool and interacting with the stool in a respective plurality of positions;

FIGS. 13-17 and 19 show a user standing near the stool and interacting with the stool in a respective plurality of positions;

FIG. 18 shows a user kneeling near the stool and interacting with the stool; and

FIG. 20 shows a user performing a handstand near the stool and interacting with the stool.

### DETAILED DESCRIPTION

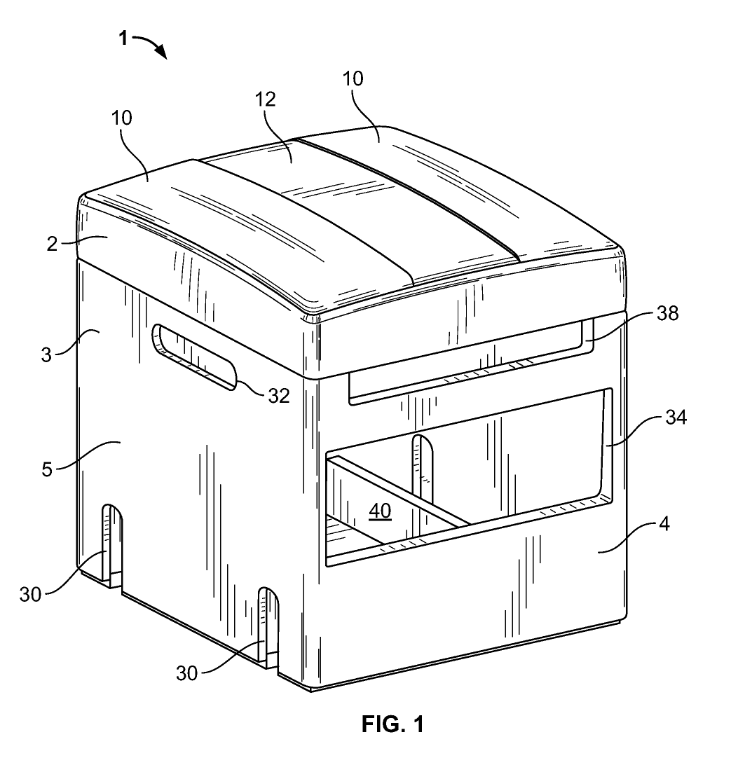

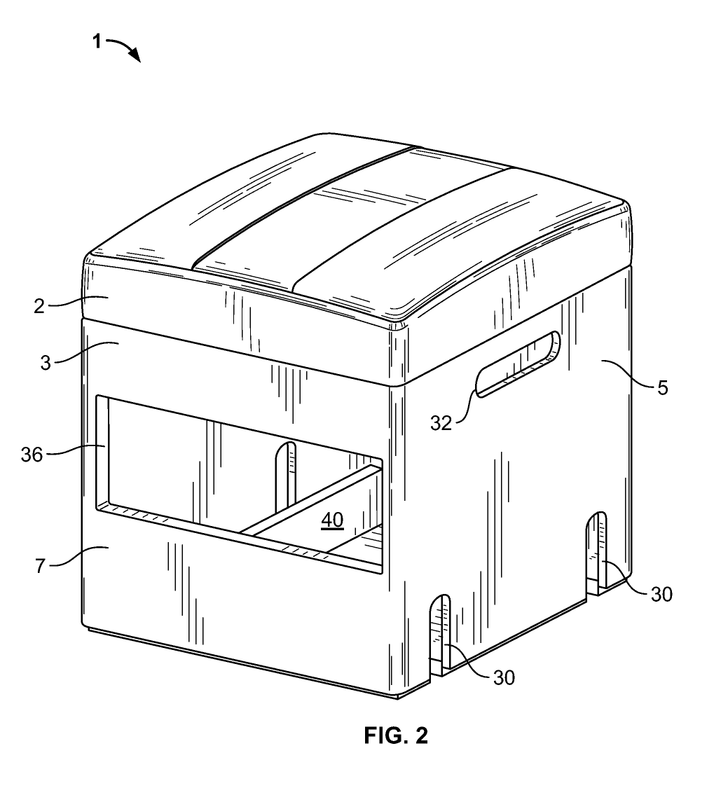

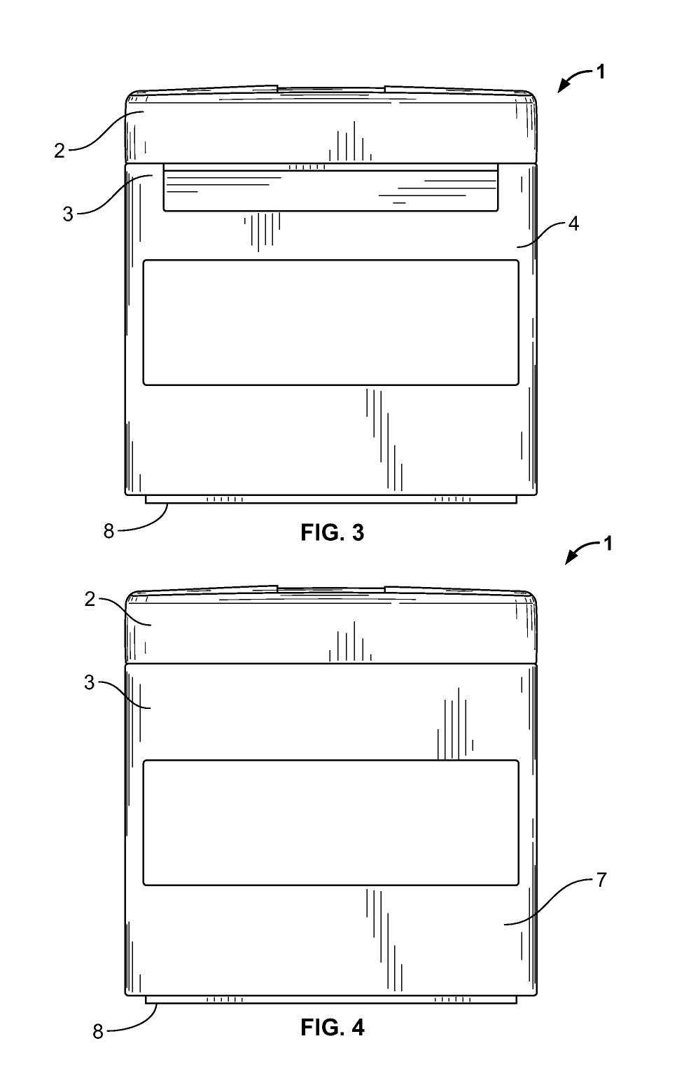

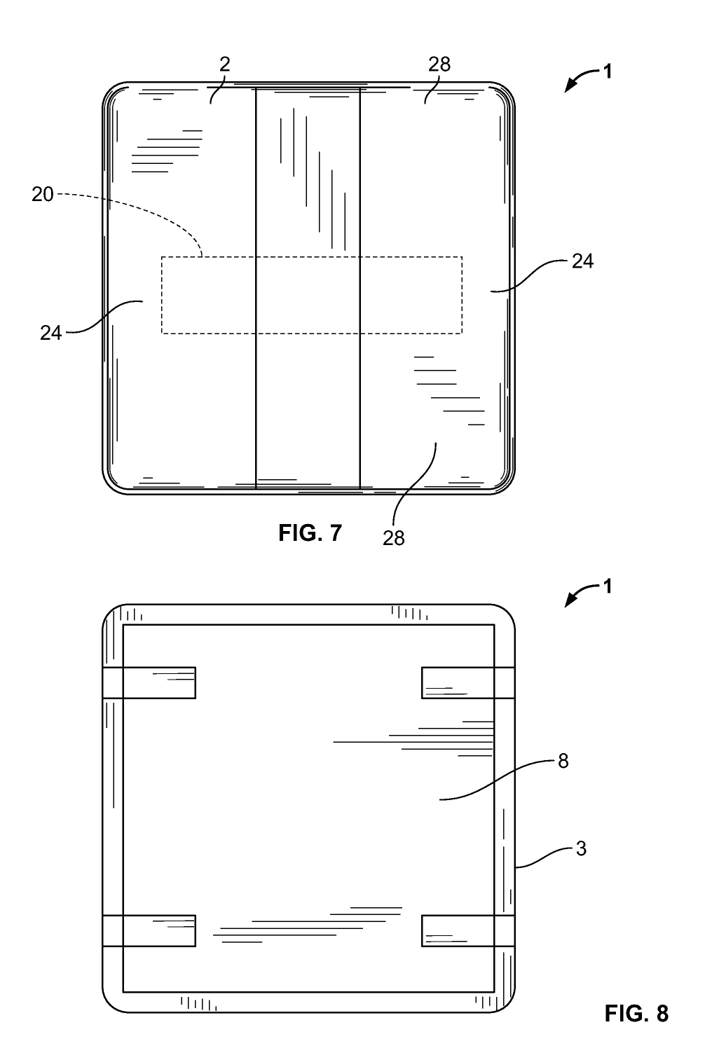

FIGS. 1-8 show a yoga stool according to an embodiment of the invention, comprising the following major parts:
yoga stool 1
seat portion (seat) 2
base portion (base) 3
front side of base 4
right side of base 5
left side of base 6
rear side of base 7
bottom of base 8

As seen in the figures, the yoga stool 1 is generally cubical in shape.

Referring to FIG. 1, the seat 2 may be covered for example by a pair of spaced-apart side strips 10 made for example of a rubber material for being securely gripped, and a middle strip 12 which may be made of cotton for a decorative effect. Other suitable materials may be used.

The seat 2 has high density foam rubber or another suitable material beneath the cover strips 10,12.

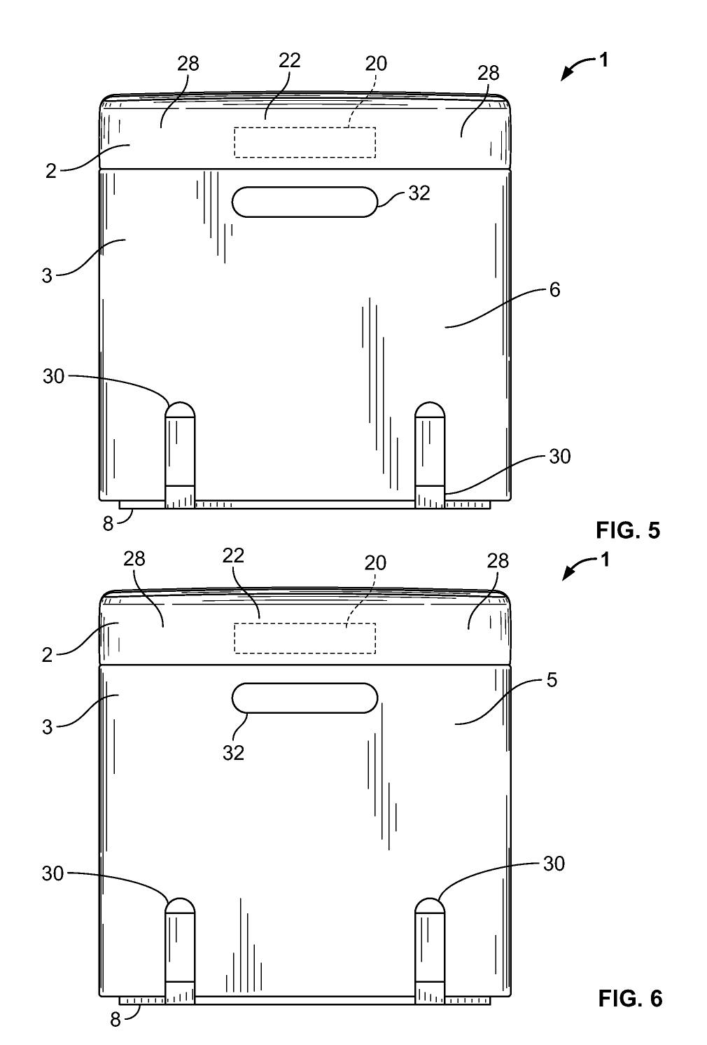

As shown in dashed lines in FIGS. 5, 6, and 7, a slat 20 which may be made of wood or another stiff material is arranged in the seat 2 for providing a firm seating surface, as well as firm support for the user's wrist, and/or the heel of the hand. The slat 20 is covered by a top layer 22 of foam rubber or the like. The slat 20 extends part way across the seat 2, between the right and left sides 5,6, leaving side portions 24 and front and rear portions 28 that are filled with foam rubber and provide a comfortable resting and gripping area for the hands.

Optionally, the slat may be omitted from the middle of the seat 2, but instead two or more smaller slats or other suitable supports may be provided within the seat.

The base 3 has four vertical side gripping slots 30 formed in lower portions of the right side 5 and the left side 6, near or at the bottom side 8, to be gripped by the user for performing various yoga postures. In this context, “lower portion” or “near or at the bottom” refers to a suitable location for performing yoga postures in conjunction with the floor.

The upper portions of the right and left sides 5,6 each have a horizontal gripping slot 32 near the top for performing other yoga postures. In this context, “upper portion” or “near or at the top” refers to a suitable location for being gripped by a user seated on the seat.

The front side 4 and the rear side 7 have respective generally rectangular window slots 34,36 extending substantially from side to side of the stool, and occupying approximately the middle third of the surface area of the respective side 4 or 7.

Optionally, rollers for foot massage may be mounted at one or both of the window slots 34,36 at a position accessible from outside the base portion for massaging the feet.

The upper portion of the front side 4 also has a handle slot 38 near or at the top of the base portion 3. In this context, “upper portion” or “near or at the top” refers to an appropriate location for carrying the yoga stool.

Also seen in the drawings are interior braces 40 near or at the bottom 8, for increasing the structural integrity of the stool. The interior of the stool may also be used for storage of other equipment, such as yoga blocks for example. Securing means such as a cover, strap, or zipper for enclosing the stored items may be provided. Anchors such as U-bolts mounted on the braces 40, for example, may also be provided for ropes, bungees, etc. for facilitating other postures and exercises.

The bottom 8 may be surfaced with rubber or another material suitable for providing secure gripping with the floor.

All of the slots and windows described above are preferably lined with foam rubber or another soft material for providing a comfortable grip or other contact point for the user.

Referring now to FIG. 9, a user is shown with heels hooked on the window slot 36 on the rear side 7 for stretching the feet.

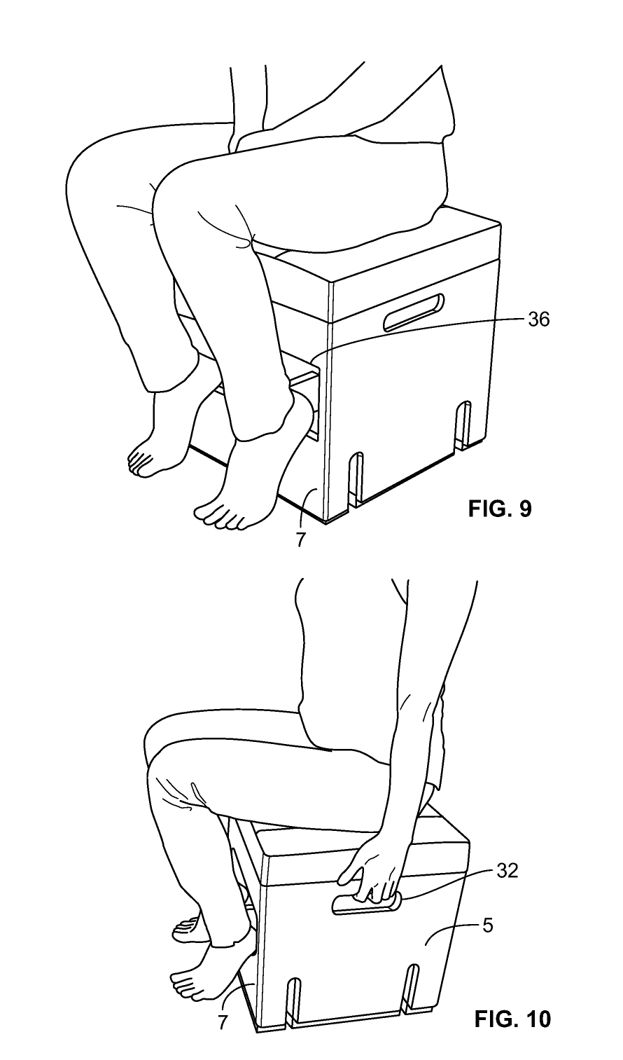

In FIG. 10, the user further has the hands gripped in the side slots 32 for stretching the spine.

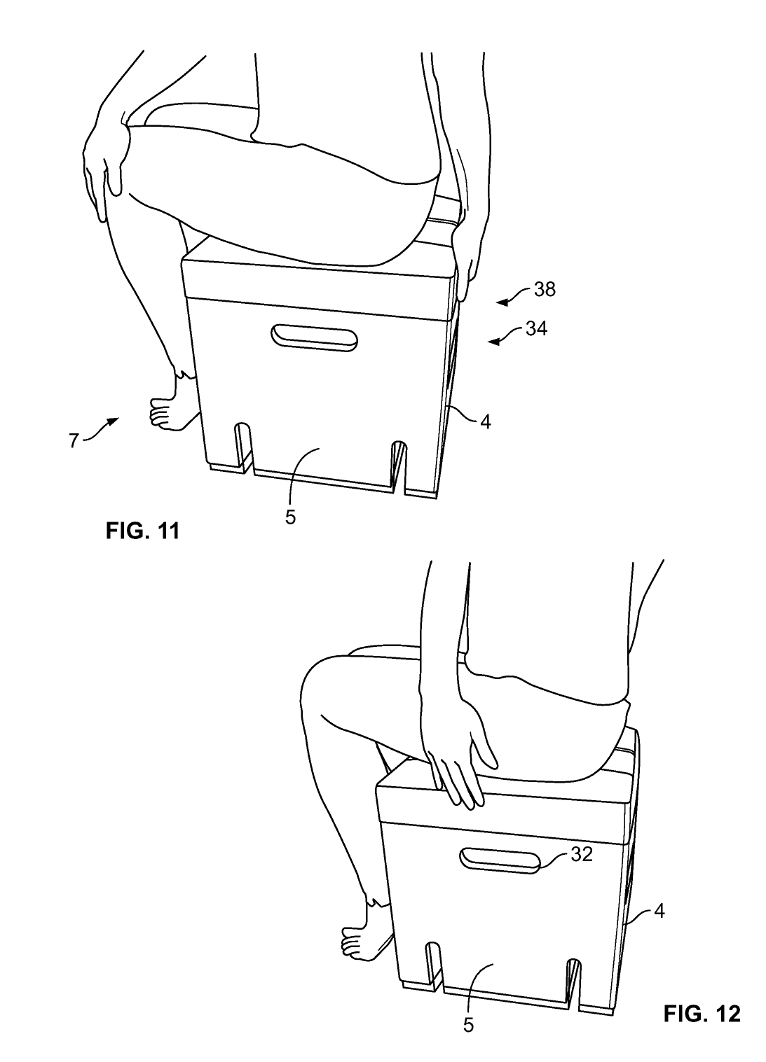

In FIG. 11, the user is performing a spinal twist with the heels on the window slot 36, the right hand on the left knee, and the left hand gripped in the top handle slot 38 on the front side 4.

In FIG. 12, the user is performing a further spinal twist with the heels on the window slot 36, the right hand on the right side 5 of the stool, and the left hand gripped in the handle slot 32 on the left side 6 of the stool.

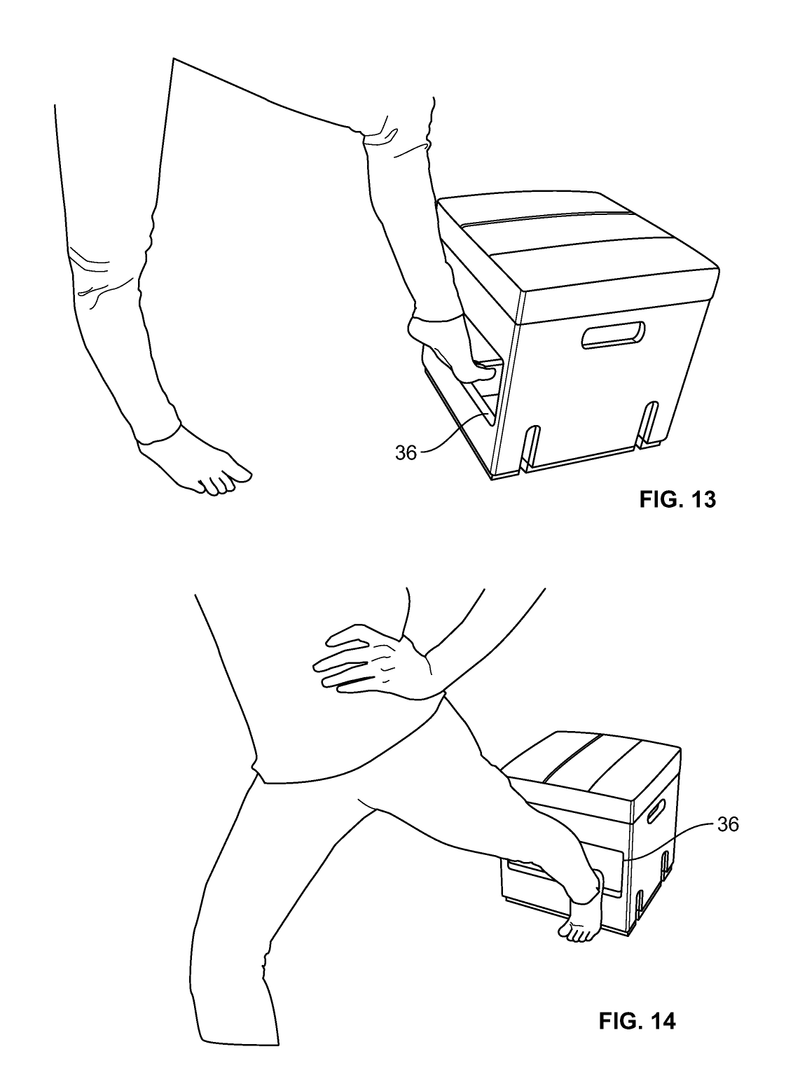

FIG. 13 shows the user with the left toes hooked on the rear window slot 36 for stretching the left leg.

FIG. 14 shows the user with the left heel hooked on the rear window slot 36 for performing another leg stretch.

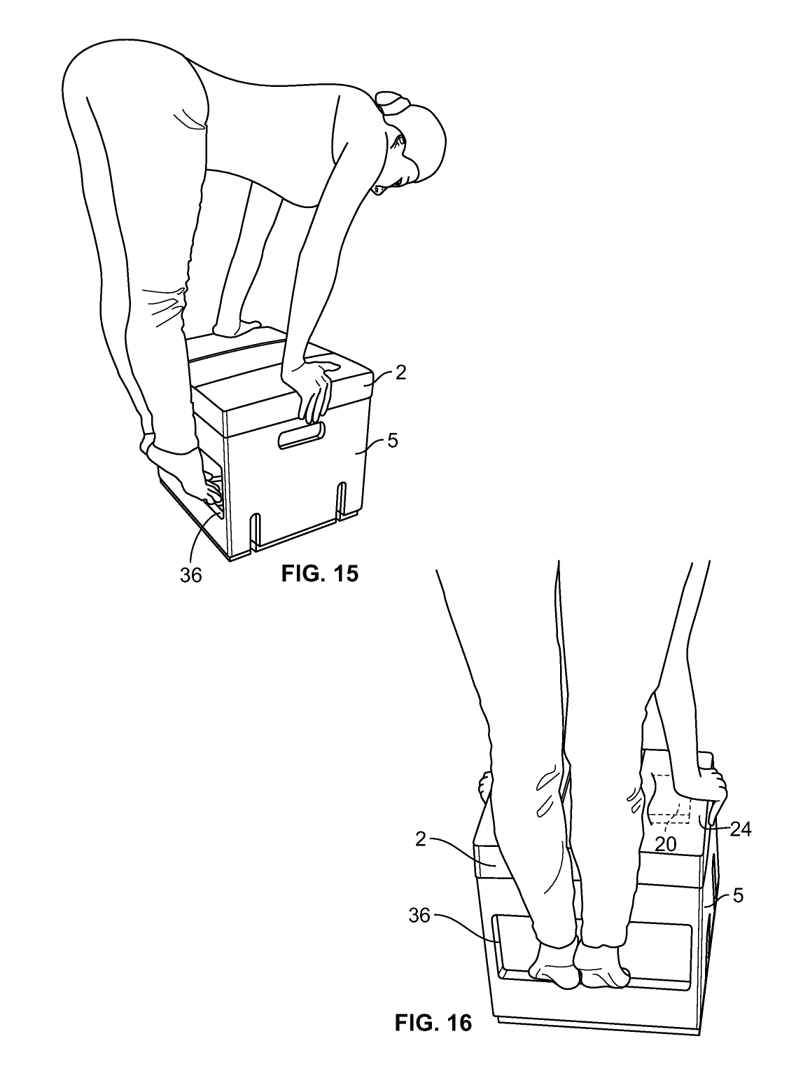

FIGS. 15 and 16 are two views showing the user with the toes of both feet hooked on the rear window slot 36 and the right and left hands disposed respectively on the right and left sides of the seat 2. The wrist and the heels of the hands are supported respectively on the right and left ends of the slat 20 inside the seat 2. The remainder of the hands extends over the side portions 24 of the seat 2 where the slat 20 is not present.

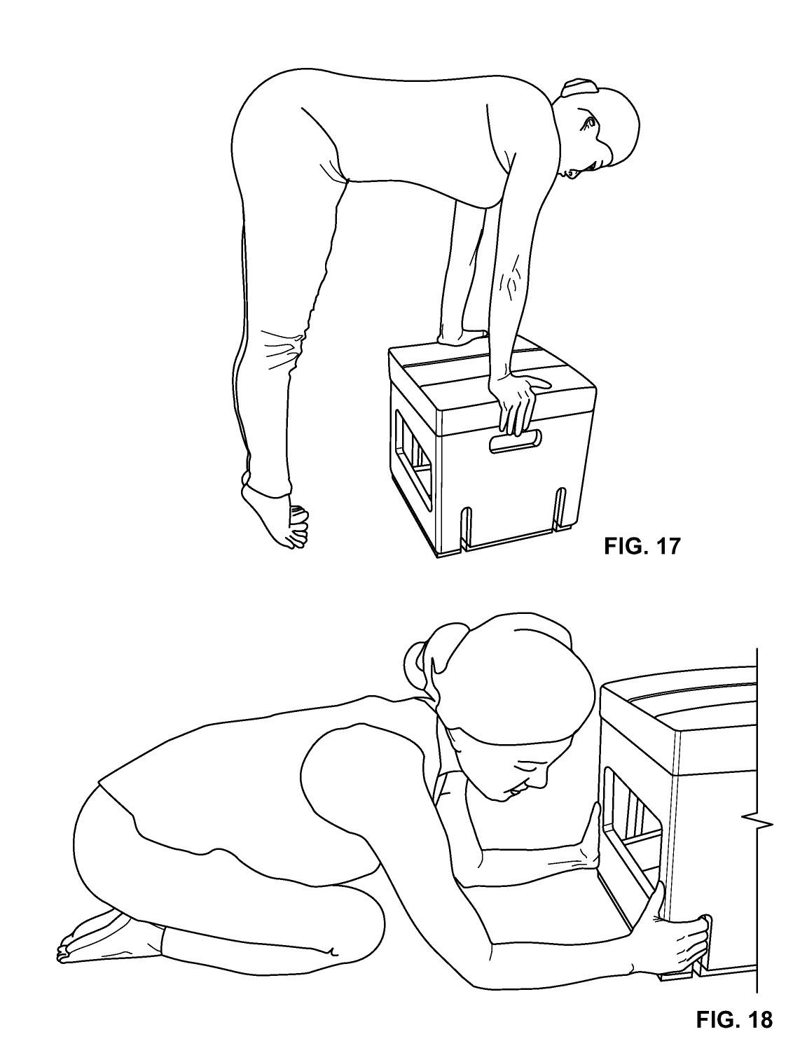

FIG. 17 is similar to FIGS. 15 and 16, but the feet have been moved away from the stool for performing a different stretch.

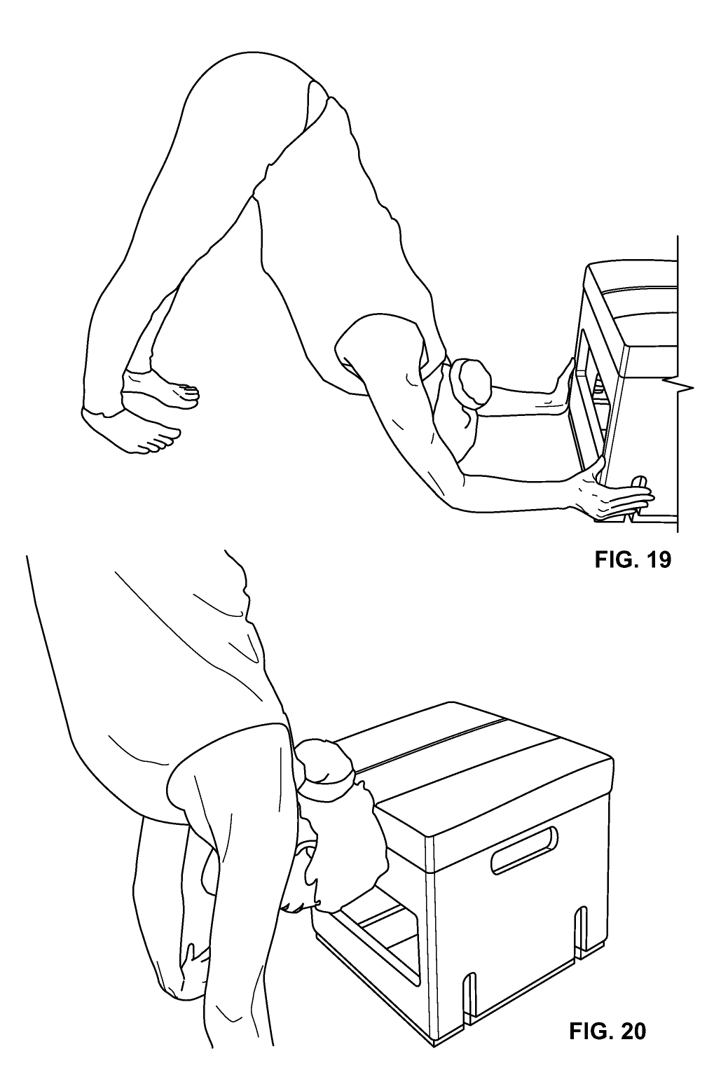

FIGS. 18 and 19 show the user gripping the vertical slots 30 at the bottom of the rear side 7 of the stool. In FIG. 18 the user is performing a kneeling posture, while in FIG. 19 the user is performing a forward bend.

FIG. 20 shows the user performing a headstand with the head braced against the rear side 7. A forearm stand may also be performed, with the hands gripping the handle slots 30 as in FIG. 18. In either of these stands, the yoga stool is advantageous because the legs can swing farther over the user's head than if the stand were performed against a wall, as is conventional. An indentation for the head may be provided on the rear side 7, the first side 4, and/or elsewhere.

Thus, the combination of elements and parts in the stool 1 provides great versatility in adapting to a wide variety of yoga positions.

In all of the positions illustrated, and other positions well known to those versed in yoga, but not shown herein, the stool 1 enhances the user's stability.

The drawings are not drawn to scale. The terms “front,” “rear,” etc. are assigned arbitrarily for purposes of this disclosure and to label the relative arrangement of the parts, but are not to be taken as limiting the structure or possible orientations of the yoga stool in actual use.

As shown and described herein, the arrangement of the seat, the handle slots, window slots and other parts has been developed by the inventor after extensive experimentation and constitutes the best known mode of practicing the invention.

Modification and variations of the disclosed stool, including alternative arrangements of slots, windows, contact areas and hand grips, may occur to those well-versed in yoga and are considered to be within the scope of the invention.

1. A yoga stool comprising:
a seat portion and a base portion;
the base portion having opposed top and bottom sides, opposed left and right sides, and opposed front and rear sides;
a window slot formed in at least one of the front side and the a rear side;
a horizontal gripping slot formed in an upper portion of at least one of the left side and the right side;
a vertical gripping slot formed in a lower portion of at least one of the left side and the right side.

2. A yoga stool according to claim 1, wherein said base portion further comprises a handle slot formed in the upper portion of at least one of the left, right, front and rear sides.

3. A yoga stool according to claim 1, comprising at least two vertical gripping slots formed respectively in the lower portions of the left side and the right side.

4. A yoga stool according to claim 3, comprising four vertical gripping slots formed in the lower portions of the left side and the right side, two of said slots being near or at the front side and two of the slots being near or at the back side.

5. A yoga stool according to claim 4, comprising two horizontal gripping slots formed respectively in the left side and the right side.

6. A yoga stool according to claim 1, wherein the bottom side is covered with a material for gripping the floor.

7. A yoga stool according to claim 1, further comprising a massage roller mounted in said window slot and accessible from outside the base portion for massaging the feet.

8. A yoga stool comprising:
a base portion, and a seat portion on top of the base portion;
the base portion having opposed top and bottom sides, opposed left and right sides, and opposed front and rear sides;
wherein the seat portion has an internal horizontal firm support member, and soft material surrounding the support member adjacent the left, right, front and rear sides.

9. A yoga stool according to claim 8, wherein the firm support member is a solid slat, and said soft material is foam rubber.

10. A yoga stool according to claim 8, wherein the bottom side is covered with a material for gripping the floor.
